(19) United States
(12) Patent Application Publication
(10) Pub. No.: US 2011/0153494 A1
(43) Pub. Date: Jun. 23, 2011

(54) Systems and Methods Associated with Distributing Financing and Risk Among Members of a Value Chain

(75) Inventors: David J Gonsalvez, Birmingham, MI (US); Robert R. Inman, Rochester Hills, MI (US)

(73) Assignee: GM GLOBAL TECHNOLOGY OPERATIONS, INC., Detroit, MI (US)

(21) Appl. No.: 12/643,464

(22) Filed: Dec. 21, 2009

(51) Int. Cl. G06Q 40/00

(52) U.S. Cl. 705/39; 705/35

(57) ABSTRACT

System and methods associated with a distributed financing model. The distributed financing model distributes financing responsibility and risk among members of a value chain to finance certain buyers of goods or services, including those who are unable to get financing through financial institutions in the traditional manner. As a result, customers are better able to buy goods or services, sellers are able to sell more, and manufacturers or service providers can produce more.

### TECHNICAL FIELD

The present disclosure relates to systems and methods associated with distributing financing and risk among members of a value chain.

### BACKGROUND

Large purchases, such as vehicle purchases, are often financed by a bank or other financial institution, which requires that buyers meet stringent credit requirements. During a credit crisis or credit market vagary, credit standards are increased making it difficult for dealers to help secure loans and leases for customers with incrementally lower credit scores. As such, sales to certain vehicle buyers are highly dependent on the credit market.

### SUMMARY

The various embodiments of the present disclosure overcome the shortcomings of traditional financing. These embodiments include systems and methods that are associated with a distributed financing model that is less dependent on the credit market. The distributed financing model distributes financing responsibility and risk among members of a value chain to finance buyers who are unable to get financing through financial institutions in the traditional manner. As a result, more buyers are able to purchase services and products (e.g., vehicles) and sellers have more sales.

The distributed financing model is applicable in many contexts. As described in further detail below, the distributed financing model is in some embodiments used in conjunction with a traditional financing model, such as in connection with a typical dealer-buyer transaction. The distributed financing model can also be used in emerging markets where buyers are not often eligible for bank credit due to their lack of credit history.

The distributed financing model is also advantageous for financing the purchase of built-to-order (BTO) vehicles and makes the associated value chain more efficient since the transaction is initiated before the vehicle is built. Another application of the distributed financing model is to the financing of electronic vehicles in order to be able to distribute the risk associated with the battery pack to the suppliers of the battery pack.

By distributing the financing responsibility and risk associated with buyers that have lower credit, the distributed financing model creates opportunities for dealers to make additional sales from their stock or of BTO vehicles. As a result, manufacturers can experience increased production, and manufacturers and dealers can obtain expanded market share and increased brand loyalty.

The foregoing has broadly outlined some of the aspects and features of the various embodiments, which should be construed to be merely illustrative of various potential applications. Other beneficial results can be obtained by applying the disclosed information in a different manner or by combining various aspects of the disclosed embodiments. Other aspects and a more comprehensive understanding may be obtained by referring to the detailed description of the exemplary embodiments taken in conjunction with the accompanying drawings, in addition to the scope defined by the claims.

### DETAILED DESCRIPTION OF THE DRAWINGS

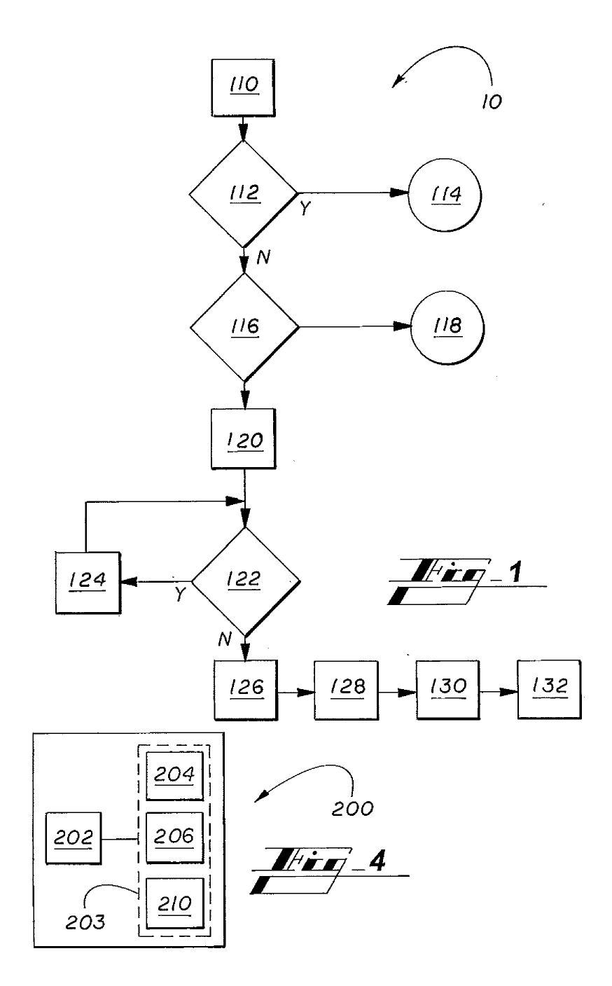

FIG. 1 is a block diagram of a method for financing a buyer, according to an exemplary embodiment of the present disclosure.

FIG. 2 is a schematic illustration of a first value chain, according to an exemplary embodiment of the present disclosure.

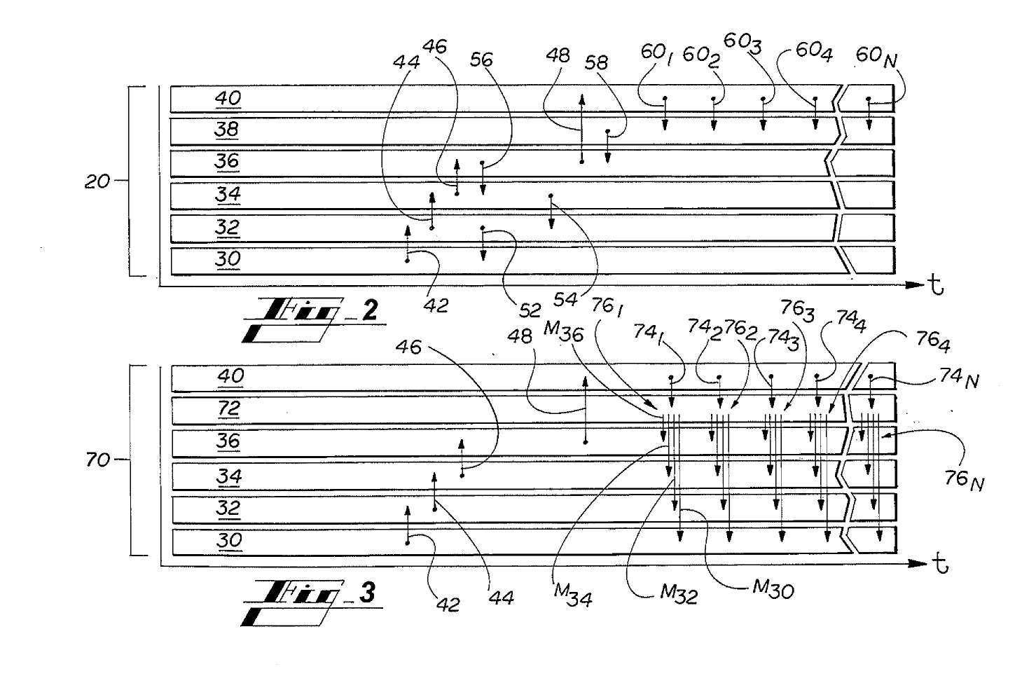

FIG. 3 is a schematic illustration of a second value chain, according to an exemplary embodiment of the present disclosure.

FIG. 4 is a schematic illustration of a system for optimizing financing according to a distributed financing model and for distributing payment shares, according to an exemplary embodiment of the present disclosure.

### DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are know to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Although the systems and methods of the present disclosure are illustrated in the context of a process for financing the sale or lease of a vehicle, the systems and methods are similarly applicable to the sale and lease of other original equipment manufacturer (OEM) products, such as computers. The systems and methods can be used by different supply chains and value chains. As used herein, a “supply chain” or “value chain” refers to a system of organizations, people, technology, activities, information and resources involved in moving a product or service from supplier to customer. Supply chain activities transform natural resources, raw materials, and components into a finished product that is delivered to the end customer. The participants in a supply chain or value chain that perform activities that add value to the product are hereinafter referred to as “stakeholders.” In an exemplary vehicle value chain, stakeholders include material suppliers, an OEM, and dealers. Alternative vehicle value chains can include alternative and/or additional stakeholders such as service providers or the employees of any of the suppliers, OEM, and dealers.

According to an exemplary embodiment illustrated in FIG. 1, a method 10 for financing the purchase or lease of a vehicle includes a main financing option for buyers that are able to obtain credit through normal channels (e.g., banks and other financial institutions) and an auxiliary financing option for buyers who do not qualify for credit through normal channels. Models for implementing the main financing option and the auxiliary financing option are further described with reference to FIGS. 2 and 3. Each model is illustrated by product flow (lines directed upward) and money flow (lines directed downward) through a value chain over time t.

In FIG. 2, product flow and money flow through a first value chain 20 are illustrated according to the main financing option. The participants in the first value chain 20 include a tier two supplier 30, a tier one supplier 32, an original equipment manufacturer (OEM) 34, a dealer 36, a bank 38 or credit institution, and a customer 40. The suppliers 30, 32 represent two tiers of suppliers. In alternative embodiments, there are fewer or more tiers and multiple suppliers in each tier. The product flow is as follows. At a first product flow step 42, the tier two supplier 30 provides parts and/or material to the tier one supplier 32. At a second product flow step 44, the tier one supplier 32 produces specialized parts and provides them to the OEM 34. At a third product flow step 46, the OEM 34 produces a product, such as a vehicle, and provides it to the dealer 36. At a fourth product flow step 48, the dealer 36 sells the vehicle to the customer 40.

Money flow associated with the main financing option illustrated in FIG. 2 is as follows. At a first money flow step 52, the tier one supplier 32 pays the tier two supplier 30 for the parts and/or material provided at the first product flow step 42. At a second money flow step 54, the OEM 34 pays the tier one supplier 32 for the specialized parts provided at the second product flow step 44. At a third money flow step 56, the dealer 36 pays the OEM 34 for the vehicle p4rovided at the third product flow step 46. At a fourth money flow step 58, the customer 40 obtains financing from the bank 38 and the bank 38 pays the OEM 38 for the vehicle provided to the customer 40 at the fourth product flow step 48. At a series of fourth money flow steps 60₁, 60₂, 60₃, 60₄ . . . 60_{N} the customer 40 makes payments to the bank 38 according to the financing terms. The product flow, money flow, and stakeholders can be altered without departing from the scope of the disclosure. For example, in alternative embodiments, the dealer 36 buys the vehicle and the bank 38 pays the dealer 36.

FIG. 3 shows product flow and money flow through a second value chain 70 over time according to the auxiliary financing option. The participants in the second value chain 70 include the tier two supplier 30, the tier one supplier 32, the OEM 34, the dealer 36, a processing company 72, and the customer 40. The processing company 72 coordinates evaluation of creditworthiness, issuing of financing, collection of monthly payments, and distribution of monthly receipts to the stakeholders 30, 32, 34, 36. Although the functions of the exemplary processing company 72 are described herein with respect to a single entity, in some embodiments, the functions of the processing company 72 are performed by two or more entities.

The product flow associated with the auxiliary financing option includes the same steps 42, 44, 46, 48 as the product flow associated with the main financing option shown in FIG. 2. The tier two supplier 30 provides parts and/or material to the tier one supplier 32, the tier one supplier 32 produces specialized parts and provides them to the OEM 34, the OEM 34 produces a vehicle and provides it to the dealer 36, and the dealer 36 sells the vehicle to the customer 40.

Money flow associated with the auxiliary financing option is as follows. The customer 40 obtains financing from the processing company 72 and, according to a series of first money flow steps 74₁, 74₂, 74₃, 74₄, 74_{N}, the customer makes payments to the processing company 72 according to the terms of a financing agreement. According to a series of second money flow steps 76, the processing company 72 makes a payment M₃₆ to the dealer 36, a payment M₃₄ to the OEM 34, a payment M₃₂ to the tier one supplier 32, and a payment M₃₀ to the tier two supplier 30 according to a distribution agreement.

According to some embodiments, the financing option is not identified prior to producing or purchasing a vehicle. In these situations, a dealer is allowed a certain percentage of sales using the auxiliary financing option. To account for sales through the auxiliary financing option, payments at money flow steps 52, 54 for the main financing option can be reduced by the percentage. As an example, according to an agreement between the stakeholders 30, 32, 34, 36, 40, each dealer orders vehicles and is allowed to sell up to 10% of the vehicles using the auxiliary financing option. The suppliers 30, 32 are paid for 90% of the cost of the vehicles at money flow steps 52, 54 to account for vehicles that are financed through the main financing option. The other 10% is left unpaid until later when payment shares M are received through money steps 76. Where the dealer does not sell the full 10% of the vehicle order using the auxiliary financing option, additional delayed payments are made to the suppliers 30, 32 at money flow steps 52, 54 to reconcile the difference.

In other embodiments, the dealer specifies the vehicles to be financed with the auxiliary financing option at the time of order. One such application is with respect to build-to-order (BTO) vehicles. As an example, the dealer is allowed to specify up to a certain percentage of their orders to be financed with the auxiliary financing option.

Referring to FIGS. 1-3, the method 10 of financing a vehicle buyer is now described in further detail. At a purchase step 110, the customer 40 initiates a lease or purchase of the vehicle supplied at the third product flow step 46. At a main financing step 112, the bank 38 determines whether the customer 40 is approved for the main financing option (e.g., acceptable credit score). If the customer 40 is approved, at an approval step 114, the dealer 36 completes the sale or lease with financing through the bank 38. Approval step 114 initiates the fourth product flow step 48 in which the vehicle is transferred to the customer 40 and the money flow steps 56, 60 in which the bank 38 pays the OEM 34 for the vehicle and the customer 40 makes payments to the bank 38 according to a financing agreement.

If the bank 38 determines that a customer is not approved at main financing step 112, the processing company 72, at an auxiliary financing step 116, determines whether the customer 40 is approved for the auxiliary financing option. If not, the method 10 is terminated at step 118 without completing the sale or lease. If the processing company 72 determines that the customer 40 is approved at the auxiliary financing step 116, the dealer 36 at an approval step 120, completes the sale or lease with financing through the processing company 72. Approval step 120 initiates the fourth product flow step 48, in which the vehicle is transferred to the customer 40, the money flow steps 74, 76, in which the customer 40 makes payments to the processing company 72 according to a financing agreement and the processing company 72 makes payments to the dealer 36, the OEM 34, the tier one supplier 32, and the tier two supplier 30 according to a distribution agreement.

After the sale or lease is completed in the approval step 120, the processing company, at a verification step 122, determines whether the customer has made a scheduled payment corresponding to the money flow step 74 of FIG. 3. If yes, at a distribution step 124, the processing company 72 apportions payment shares M to stakeholders 30, 32, 34, 36 according to the distribution agreement at the associated money flow step 76 and the method 10 returns to verification step 122 for the next money flow step 74. The processing company 72 may keep a portion of the payment to cover costs.

FIG. 4 shows a system 200, such as one or more servers including a processor 202, a memory 203, and software modules stored in the memory 203. The software modules include instructions that, when executed by the processor 202, perform the steps of the method 10. For example, in some embodiments, the system 200 includes a receiving software module 204 configured by including instructions to receive indication that a customer payment has been made at a money flow step 76. The receiving software module 204 is further configured to receive parameters of the payment, such as the amount and timing of the payment, and to verify whether the payment meets preset guidelines, such as guidelines of the financing agreement. The receiving software module 204 is further configured to store or initiate storing of payment information associated with the payment, such as the indication of payment, the amount, the timing, whether the amount is appropriate, and whether the timing was appropriate. The receiving software module 204 may store or initiate storage of the payment info in the receiving software module 204, another part of the memory 203, or in a memory separate from the memory 203. The payment info is stored in an account associated with the customer. In some embodiments, the system 200 includes a distributing software module 206 configured to transfer payment shares M to accounts associated with the stakeholders. Though functions of the system 200 are described as occurring in three software modules, the functions of the system 200 may be performed by one or more software modules. For example, a combined module may perform tasks of two or more modules and the functions of any two or more modules may be performed in a single module.

In the event that the receiving software module 204 determines that a customer has not made a schedule payment at a money flow step 74, the processing company 72, at a step 126, determines whether to initiate a repossession process. The decision may be based on the appropriateness of the payment or the appropriateness of the timing. An exemplary repossession process includes a step 128 of physically repossessing the vehicle, a step 130 of selling the vehicle at auction, and a step 132 of distributing the auction proceeds to the stakeholders 30, 32, 34, 36, such as according to agreements regarding distributing auction proceeds. The agreements for distributing auction proceeds may be a part of or separate from the distribution agreement for distributing customer payments.

The system 200 may include software modules and computer readable instructions for performing one or more of the steps of the methods described herein and illustrated in FIGS. 1 and 3. For example, one or more software modules can be configured to perform steps 112, 116.

The financing agreement and distribution agreement for distributing monthly customer payments are associated with the auxiliary financing option are now described in further detail, and with reference to equations (1), (2) and (3) below. At the initiation of financing, the customer provides a down payment and monthly payments C of principal and interest are scheduled for amortization of the balance P according to terms of the financing agreement, including a customer interest rate i_{c}. An exemplary calculation of the monthly payments C is given by

$$C = \frac{{i}_{c} P}{1 - {( 1 + {i}_{c} )}^{- n}} , \qquad ( 1 )$$

where n is the number of payments to be made according to the amoritization.

Each payment C is then divided into payment shares M and distributed to the stakeholders by the processing company 72, according to the corresponding money flow step 76. An exemplary algorithm to determine monthly payment shares M to stakeholders 30, 32, 34, 36 is given as:

$${M}_{j} = \frac{{i}_{j} ( {R}_{j} ) {PV}_{j}}{1 - {( 1 + {i}_{j} ( {R}_{j} ) )}^{- n}} , \qquad ( 2 )$$

where n is the number of monthly payments to be made by customer, P is the value of the vehicle or balance of the sales price, j is a stakeholder index, Rⱼ is a risk tier for a stakeholder, iⱼ is an interest rate for a stakeholder, and Vⱼ is the fraction of the vehicle's total value or sales price P attributed to a stakeholder.

The risk tiers Rⱼ are classes of stakeholders with facing similar amounts of risk. Major sources of a stakeholder's risk are the length of time the stakeholder may need to wait for payment, and the amount of control over outcomes (such as authority to determine how many vehicles are eligible for auxiliary financing, which vehicles are built and which are eligible for auxiliary financing, which customers to offer auxiliary financing, and pricing incentives). Stakeholders with higher risk can be compensated with higher stakeholder interest rates. Higher risk tiers Rⱼ include stakeholders confronting more risk and lower risk tiers Rⱼ include stakeholders confronting less risk. A stakeholder in a higher risk tier may be given a higher interest rate than a stakeholder in a lower risk tier. According to exemplary embodiment, the distributing software module 206 is configured to determine payment shares.

The fraction Vⱼ of the vehicle's value P is a percentage of sales price of the vehicle. For example, for a vehicle that sells for $20,000, with dealer 36 costs and margin of $3,000, OEM 34 structural costs (e.g. Advertising, Manufacturing, Engineering, etc.) of $5000, OEM 34 variable costs (e.g. Freight, Warranty, etc.) of $1000, supplier 30, 32 material costs (all suppliers) of $10,000, and OEM 34 profit of $1000, the OEM 34 fraction V is 35%, the dealer 36 fraction V is 15%, and the supplier 30, 32 fraction V is 50%.

The financing agreement and the distribution agreement are related and the parameters in the agreements can be optimized as desired by the processing company 72 and the stakeholders. The monthly customer payment C can be determined as the sum of the monthly payment shares M given by

$$C = {\sum }_{j} {M}_{j} \qquad ( 3 )$$

As such, the customer interest rate i_{c} is related to the stakeholder interest rates iⱼ. In some embodiments, the stakeholder interest rates iⱼ are optimized using a net present value (NPV) analysis so that each stakeholder's NPV is the same as in the main financing option to identify a set of minimum stakeholder interest rates. Alternatively, stakeholders may accept lower interest rates if plant utilization is low, or require higher interest rates if plant utilization is high. The minimum stakeholder interest rates are then used to calculate the minimum required customer interest rate. The processing company determines the actual customer interest based on this minimum, the customer's creditworthiness, the amount of the customer's down payment, and the interest rate offered by the main financing option for more creditworthy customers. The customer interest rate, the number of payments, the down payment, and the purchase price determine the resulting monthly customer payment C.

The agreement for distributing auction proceeds upon default according to steps 126, 128, 130, 132 is now further described. In some embodiments, default shares are distributed as fractions of the proceeds from auction or recovered value. Alternatively or additionally, in some embodiments, default shares can be distributed according to seniority or a hierarchy. For example, only after the highest seniority stakeholder has recovered its risk capital is the next highest seniority level considered for a share of the recovered value. Default shares may be proportionally different than the fractions V of the vehicles value P and seniority is not necessarily proportional to default share size. For example, a smallest stakeholder can be assigned the highest seniority, a second smallest stakeholder can be assigned the second highest seniority, etc.

Referring again to FIG. 4, according to some embodiment of the present disclosure, the system 200 further includes an analysis software module 210 that is configured to optimize input and output parameters. The analysis software module 210 queries which parameters are output parameters and queries values for key input parameters. The parameters include stakeholder interest rates payment shares M, monthly payment C, customer interest rate i_{c}, transaction price P, dealer costs and margin, dealer floorplan and incentives, time in dealer inventory, OEM variable costs (e.g. labor), OEM fixed costs, OEM material costs to suppliers, number of suppliers, supplier share of material cost, and period or number of customer payments n. The analysis software module 210 determines, for each stakeholder, output parameters including the nominal price of goods sold per vehicle, material cost per vehicle, labor cost per vehicle, the ratio of structural to variable costs, and the risk tier.

The analysis software module 210 is configured to optimize the parameters according to one or more of the following methods: optimizing customer interest rate i_{c} so that the OEM does not make a profit; optimizing customer interest rate i_{c} so that the stakeholders experience the same NPV as that of the main financing option; and optimizing the customer interest rate i_{c} such that the stakeholders realize a higher NPV than that of the main financing option.

The above-described embodiments merely illustrate implementations that are set forth for a clear understanding of principles. Variations, modifications, and combinations of the above-described embodiments may be made without departing from the scope of the claims. All such variations, modifications, and combinations are included herein by the scope of this disclosure and the following claims.

1. A system for determining terms for a distributed financing model for use in connection with a customer lease or purchase of a service or product provided by stakeholders in a supply chain, comprising:
a processor; and
at least one software module including computer readable instructions that, when executed by the processor, cause the processor to:
determine payment shares, each payment share associated with one of the stakeholders; and
determine a customer payment and/or a customer interest rate as a function of the payment shares.

2. The system of claim 1, wherein the instructions that, when executed by the processor, cause the processor to determine the payment shares using a net present value analysis.

3. The system of claim 1, wherein the instructions that, when executed by the processor, cause the processor to determine the customer payment as a sum of the payment shares.

4. The system of claim 1, wherein the instructions that, when executed by the processor, cause the processor to determine each payment share, cause the processor to determine each payment share as a function of a fraction of a price of a product or a service that is associated with a corresponding stakeholder.

5. The system of claim 4, wherein the instructions that, when executed by the processor, cause the processor to determine each payment share as a function of the fraction of the price of the product or the service that is associated with the corresponding stakeholder, cause the processor to determine the fraction as a function of fixed costs and/or variable costs.

6. The system of claim 4, wherein the instructions that, when executed by the processor, cause the processor to determine each payment share as a function of the fraction of the price of the product or the service that is associated with the corresponding stakeholder, cause the processor to determine each payment share as a function of a stakeholder interest rate.

7. The system of claim 1, wherein the instructions that, when executed by the processor, cause the processor to determine payment shares, cause the processor to determine each payment share as a function of a stakeholder interest rate.

8. The system of claim 7, wherein the instructions, when executed by the processor, cause the processor to place the stakeholders in risk tiers, each risk tier having an associated stakeholder interest rate.

9. The system of claim 1, wherein each payment share is determined according to
$${M}_{j} = \frac{{i}_{j} {PV}_{j}}{1 - {( 1 + {i}_{j} )}^{- n}} ,$$
where Mⱼ is the payment share, n is a number of payments to be made by a customer, P is a price of a product or service, j is a stakeholder index, iⱼ is stakeholder interest rate, and Vⱼ is a fraction of the product or service price attributed to a stakeholder.

10. A system for administering a collection and distribution process associated with a financed vehicle purchase or lease, each of a plurality of stakeholders contributing value to a process of producing and selling a vehicle, comprising:
a processor; and
at least one software module comprising computer readable instructions that, when executed by the processor, cause the processor to:
receive indication of a customer payment;
distribute shares of a received customer payment to stakeholders.

11. The system of claim 10, further comprising instructions that, when executed by the processor, cause the processor to distribute shares of proceeds from a repossession process to stakeholders.

12. The system of claim 10, wherein the instructions that when executed by the processor, distribute shares of the received customer payment to stakeholders, cause the processor to distribute payment shares that are determined using a net present value analysis.

13. The system of claim 10, wherein the customer payment is a sum of the payment shares.

14. The system of claim 10, wherein each payment share is a function of a fraction of the vehicle's purchase or lease price that is associated with a stakeholder.

15. The system of claim 14, wherein the fraction is a function of fixed costs and/or variable costs.

16. The system of claim 14, wherein each payment share is a function of a stakeholder interest rate.

17. The system of claim 10, wherein each payment share is a function of a stakeholder interest rate.

18. The system of claim 10, wherein each payment share is determined according to
$${M}_{j} = \frac{{i}_{j} {PV}_{j}}{1 - {( 1 + {i}_{j} )}^{- n}} ,$$
where Mⱼ is the payment share, n is a number of payments to be made by a customer, P is the price of the purchase or lease of a vehicle, j is a stakeholder index, iⱼ is stakeholder interest rate, and Vⱼ is a fraction of vehicle's value attributed to a stakeholder.
